(19) United States
(12) Patent Application Publication
(10) Pub. No.: US 2012/0319663 A1
(43) Pub. Date: Dec. 20, 2012

(54) LOAD-TESTING CIRCUIT FOR USB PORTS

(75) Inventors: JIN-LIANG XIONG, Shenzhen City (CN); HAI-QING ZHOU, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/213,073

(22) Filed: Aug. 18, 2011

(30) Foreign Application Priority Data
Jun. 16, 2011 (CN) 201110161453.9

(51) Int. Cl. G05F 1/10

(52) U.S. Cl. 323/271

(57) ABSTRACT

A power supply circuit is configured for simulating the maximum standard load currents for different kinds of USB ports, and each of the USB ports includes a power terminal; the load-testing circuit includes a voltage regulating circuit, a voltage dividing circuit, a first operational amplifier, a first transistor, and a current limiting resistor. The voltage regulating circuit is configured for supplying a reference voltage to the voltage dividing circuit. The reference voltage is divided by sub-circuits of the voltage dividing circuit. When the sub-circuit connected to the voltage regulating circuit and the first operational amplifier is changed, a current flows from the first transistor and the current limiting resistor is changed.

### BACKGROUND

1. Technical Field

The present disclosure relates to load-testing circuits, and particularly, to a load-testing circuit for USB ports.

2. Description of Related Art

USB ports include four different kinds, such as type 1.0, type 1.1, type 2.0, and type 3.0. The maximum standard load currents of the USB ports respectively are 100 mA, 150 mA, 500 mA, and 900 mA. Typically, one load-testing circuit can simulate only one maximum standard load current. As a result, different load-testing circuits must be designed for different kinds of USB ports which is inconvenient and costly.

Therefore, it is desirable to provide a load-testing circuit which can overcome the limitations described above.

### BRIEF DESCRIPTION OF THE DRAWINGS

FIG. 1 is a circuit diagram of a load-testing circuit, according to a first exemplary embodiment.

FIG. 2 is a circuit diagram of a load-testing circuit, according to a second exemplary embodiment.

### DETAILED DESCRIPTION

Exemplary embodiments of the disclosure will be described in detail, with reference to the accompanying drawings.

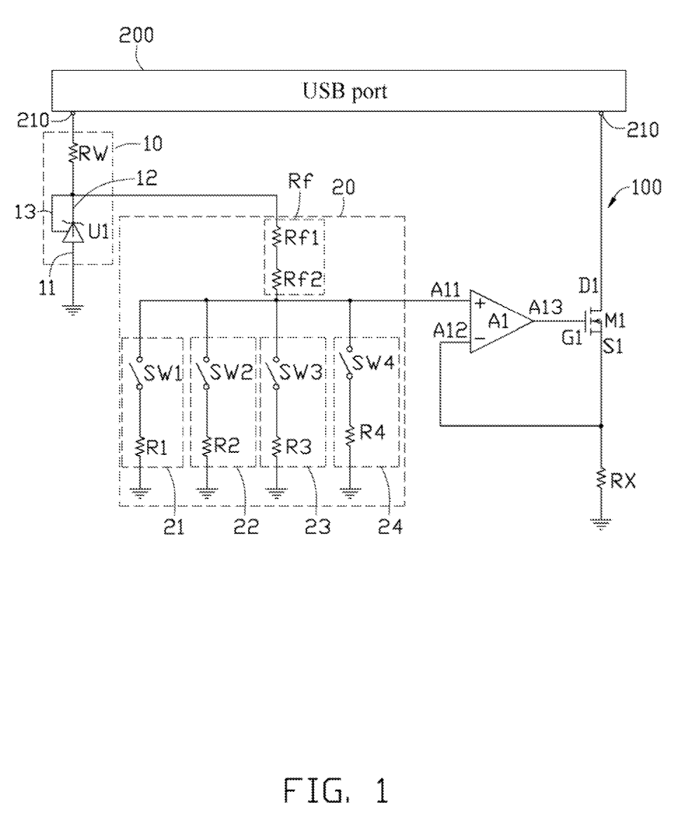

FIG. 1 is a circuit diagram of a load-testing circuit 100, according to a first exemplary embodiment. The load-testing circuit 100 is configured for simulating different maximum standard load currents for USB ports 200 when the USB ports 200 are under test. The USB ports 200 include a power terminal 210. The load-testing circuit 100 includes a voltage regulating circuit 10, a voltage dividing circuit 20, a first operational amplifier A1, a first transistor M1, and a current limiting resistor Rx.

The voltage regulating circuit 10 includes a three-terminal regulator U1 and a regulating resistor Rw. The three-terminal regulator U1 includes an anode 11 that is grounded, a cathode 12 connected to the power terminal 210 via the regulating resistor Rw, and a reference terminal 13 connected to the cathode 12. The voltage regulating circuit 10 outputs a reference voltage Vf from the cathode 12. In this embodiment, the voltage value provided by the power terminal 210 is +5 v and the reference voltage Vf is +2.5 v.

The voltage dividing circuit 20 includes a resistance module Rf, a first sub-circuit 21, a second sub-circuit 22, a third sub-circuit 23, and a fourth sub-circuit 24. The resistance module Rf includes a first terminal connected to the cathode 12 of the three-terminal regulator U1, and a second terminal. The first sub-circuit 21 includes a first resistor R1 and a first switch SW1. One terminal of the first switch SW1 is grounded via the first resistor R1, and the other terminal of the first switch SW1 is connected to the second terminal of the resistance module Rf. The second sub-circuit 22 includes a second resistor R2 and a second switch SW2. One terminal of the second switch SW2 is grounded via the second resistor R2, and the other terminal of the second switch SW2 is connected to the second terminal of the resistance module Rf. The third sub-circuit 23 includes a third resistor R3, and a third switch SW3. One terminal of the third switch SW3 is grounded via the third resistor R3, and the other terminal of the third switch SW3 is connected to the second terminal of the resistance module Rf. The fourth sub-circuit 24 includes a fourth resistor R4 and a fourth switch SW4. One terminal of the fourth switch SW4 is grounded via the fourth resistor R4, and the other terminal of the fourth switch SW4 is connected to the second terminal of the resistance module Rf.

The resistance module Rf includes a first dividing resistor Rf1 and a second dividing resistor Rf2 connected to the first dividing resistor Rf1. One terminal of the first dividing resistor Rf1 is connected to one terminal of the second dividing resistor Rf2. The other terminal of the first dividing resistor Rf1 serves as the first terminal of the resistance module Rf, and the other terminal of the second dividing resistor Rf2 serves as the second terminal of the resistance module Rf.

The resistances of the first resistor R1, the second resistor R2, the third resistor R3, and a fourth resistor R4 are all different. In this embodiment, the resistances of the first dividing resistor Rf1 and the second dividing resistor Rf2 are about 2,000 ohms, the resistance of the first resistor R1 is about 85 ohms, the resistance of the second resistor R2 is about 130 ohms, the resistance of the third resistor R3 is about 510 ohms, and the resistance of the fourth resistor R4 is about 1120 ohms.

The first operational amplifier A1 includes a first positive input terminal A11, a first negative input terminal A12, and a first output terminal A13. The first positive input terminal A11 is connected to the second terminal of the resistance module Rf.

The first transistor M1 includes a first drain D1, a first source S1, and a first gate G1 configured for controlling connections and disconnections between the first drain D1 and the first source S1. The first drain D1 is connected to the power terminal 210, the first source S1 is connected to the first negative input terminal A12, and the first gate G1 is connected to the first output terminal A13.

One terminal of the current limiting resistor Rx is connected to the first negative input terminal A12 and the first source S1, and the other terminal of the current limiting resistor Rx is grounded. The resistance of the current limiting resistor Rx is about 1 ohm.

In use, when one of the USB ports 200 is tested, one switch of the first switch SW1, the second switch SW2, the third switch SW3, and the fourth switch SW4 is turned on. The correspondence between the types of the USB ports 200 and the sub-circuits is that when the tested USB port 200 is a type 1.0, the first switch SW1 of the first sub-circuit 21 is turned on; when the tested USB port 200 is a type 1.1, the second switch SW2 of the second sub-circuit 22 is turned on; when the tested USB port 200 is a type 2.0, the third switch SW3 of the third sub-circuit 23 is turned on; when the tested USB port 200 is a type 3.0, the fourth switch SW4 of the fourth sub-circuit 24 is turned on.

The reference voltage Vf is divided by the resistance module Rf and one of the sub-circuits, the voltage of the first positive input terminal A11 of the first operational amplifier A1 is V1. According to the virtual short principle applied to the first operational amplifier A1, the voltage of the first negative input terminal A12 is V1. The first operational amplifier A1 keeps outputting a high level signal, such as 5 volt, to the first gate G1 of the first transistor M1. The first source S1 is connected to the first drain D1. A current flowing through the current limiting resistor Rx is V1/Rx.

For example, when the tested USB port 200 is the 2.0 type, the third switch SW3 of the third sub-circuit 23 is turned on and other sub-circuits 23 are turned off. The reference voltage Vf is divided by the resistance module Rf and the third sub-circuit 23, and V1/Rx=900 mA. Therefore, the load-testing circuit 100 simulates a maximum standard load current of the 2.0 type in relation to the USB port 200.

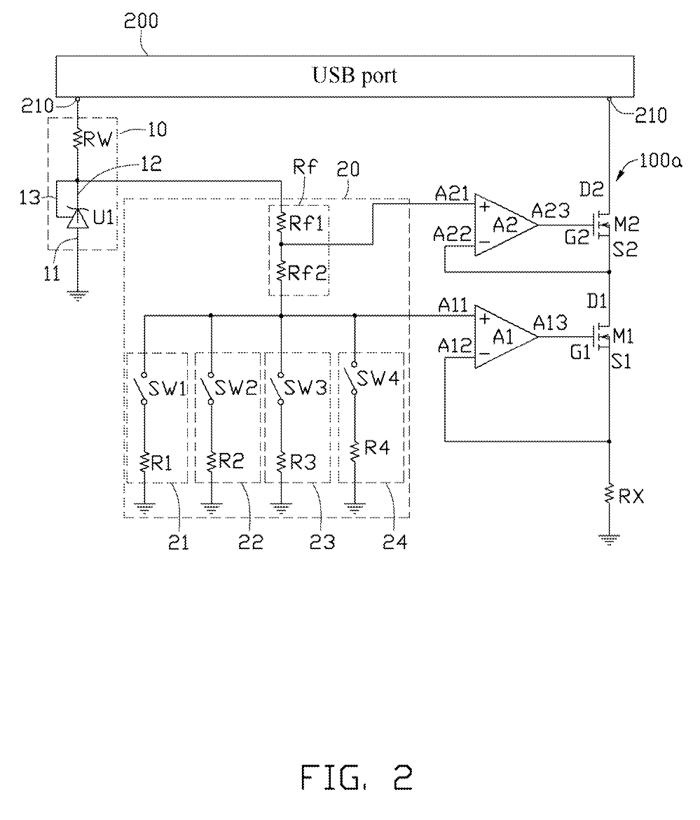

FIG. 2 is a circuit diagram of a load-testing circuit 100a, according to a second exemplary embodiment. The difference between the load-testing circuit 100a of the second exemplary embodiment and the load-testing circuit 100 of the first exemplary embodiment is the load-testing circuit 100a further includes a second operational amplifier A2 and a second transistor M2. The second operational amplifier A2 includes a second positive input terminal A21, a second negative input terminal A22, and a second output terminal A23. The second positive input terminal A21 is connected between the first dividing resistor Rf1 and the second dividing resistor Rf2. The second transistor M2 includes a second drain D2, a second source S2, and a second gate G2 configured for controlling connections and disconnections between the second drain D2 and the second source S2. The second drain D2 is connected to the power terminal 210. The second source S2 is connected to the second negative input terminal A22 and the first drain D1. The second gate G2 is connected to the second output terminal A23.

The first operational amplifier A1 and the second operational amplifier A2 keep outputting a high level signal from the first output terminal A13 and the second output terminal A23 respectively. Therefore, the output current from the power terminal 210 flows through the first transistor M1, the second transistor M2, and the current limiting resistor Rx. The second operational amplifier A2 and the second transistor M2 share the power consumption of the first operational amplifier A1 and the first transistor M1.

It will be understood that particular exemplary embodiments are shown and described by way of illustration only. The principles and the features of the present disclosure may be employed in various and numerous exemplary embodiments thereof without departing from the scope of the disclosure as claimed. The above-described exemplary embodiments illustrate the scope of the disclosure but do not restrict the scope of the disclosure.

What is claimed is:

1. A load-testing circuit configured for simulating maximum standard load currents of different kinds of USB ports, each of the USB ports comprising a power terminal; the load-testing circuit comprising:
a voltage regulating circuit connected to the power terminal, and configured for supplying a reference voltage;
a voltage dividing circuit receiving the reference voltage from the voltage regulating circuit, and comprising a plurality of sub-circuits, each of the sub-circuits comprising a resistor having a different resistance;
a first operational amplifier comprising a first positive input terminal connected to the voltage dividing circuit, a first negative input terminal is grounded via a current limiting resistor, and a first output terminal; and
a first transistor comprising a first drain connected to the first negative input terminal, a first source connected to the power terminal, and a first gate connected to the first output terminal.

2. The load-testing circuit in claim 1, wherein the voltage regulating circuit comprises a three-terminal regulator and a regulating resistor; the three-terminal regulator comprises an anode being grounded, a cathode connected to the power terminal via the regulating resistor, and a reference terminal connected to the cathode; the voltage regulating circuit outputs the reference voltage from the cathode.

3. The load-testing circuit in claim 2, wherein the voltage dividing circuit comprises a resistance module, a first sub-circuit, a second sub-circuit, a third sub-circuit, and a fourth sub-circuit; the resistance module comprises a first terminal connected to the cathode of the three-terminal regulator and a second terminal connected to the first positive input terminal; one terminal of each of the first sub-circuit, the second sub-circuit, the third sub-circuit, and the fourth sub-circuit is connected to the second terminal of the resistance module, and the other terminal is grounded.

4. The load-testing circuit in claim 3, wherein the first sub-circuit comprises a first resistor and a first switch, one terminal of the first switch is grounded via the first resistor, and the other terminal is connected to the second terminal of the resistance module; the second sub-circuit comprises a second resistor and a second switch, one terminal of the second switch is grounded via the second resistor, and the other terminal is connected to the second terminal of the resistance module; the third sub-circuit comprises a third resistor and a third switch, one terminal of the third switch is grounded via the third resistor, and the other terminal is connected to the second terminal of the resistance module; the fourth sub-circuit comprises a fourth resistor and a fourth switch, one terminal of the fourth switch is grounded via the fourth resistor, and the other terminal is connected to the second terminal of the resistance module.

5. The load-testing circuit in claim 4, wherein the resistances of the first resistor, the second resistor, the third resistor, and the fourth resistor are all different.

6. The load-testing circuit in claim 5, wherein the resistances of the resistance module is 2000 ohm, the resistance of the first resistor is 85 ohms, the resistance of the second resistor is 130 ohm, the resistance of the third resistor is 510 ohms, and the resistance of the fourth resistor is 1120 ohms, the resistance of the current limiting resistor is 1 ohm.

7. The load-testing circuit in claim 1, wherein the resistance module comprises a first dividing resistor and a second dividing resistor connected to the first dividing resistor, the other terminal of the first dividing resistor serves as the first terminal of the resistance module, and the other terminal of the second dividing resistor serves as the second terminal of the resistance module.

8. The load-testing circuit in claim 1, wherein the resistances of the first dividing resistor and the second dividing resistor are 1000 ohms.

9. The load-testing circuit in claim 1, further comprising a second operational amplifier and a second transistor; wherein the second operational amplifier comprises a second positive input terminal connected between the first dividing resistor and the second dividing resistor, a second negative input terminal, and a second output terminal; the second transistor comprises a second drain connected to the power terminal, a second source connected to the second negative input terminal and the first drain, and a second gate connected to the second output terminal.
